(19) United States
(12) Patent Application Publication
(10) Pub. No.: US 2006/0153088 A1
(43) Pub. Date: Jul. 13, 2006

(54) Method and system of insuring that a user receives a multicast television signal when changing channels during a control mode switch over

(76) Inventors: Allen Tsz-Chiu Wong, San Jose, CA (US); Zhidan Cheng, Sunnyvale, CA (US)

Correspondence Address: LAW OFFICES OF MARK C. PICKERING, P.O. BOX 300, PETALUMA, CA, 94953, US

(21) Appl. No.: 10/996,844

(22) Filed: Nov. 23, 2004

(51) Int. Cl. H04J 1/16; H04J 3/16

(52) U.S. Cl. 370/252; 370/466

(57) ABSTRACT

In a communications network, an end user (set top box) can leave a first group, join a second group (change television channels), and receive data from the second group (new television channel) while a control module of the communications network is unavailable. The network detects when the control module is unavailable and, when unavailable, generates and responds to control information sent in data packets over the switching network.

### BACKGROUND OF THE INVENTION

1. Field of the Invention

The present invention relates to a method and system of receiving multicast television signals and, more particularly, to a method and system of insuring that a user receives a multicast television signal when changing channels during a control mode switch over.

2. Description of the Related Art

In a communications network that supports the Internet Group Multicast Protocol (IGMP), Version 1 (RFC 1112) and/or Version 2 (RFC 2236), multicast sources output streams of multicast data packets to the network. Each multicast data packet, in turn, has an associated multicast group address.

The multicast data packets can represent, for example, television channels that are identified by the multicast group addresses. For example, a multicast data packet of television channel 1 can have a first multicast group address, while a multicast data packet of television channel 2 can have a second multicast group address.

The multicast data packets (television channels) are forwarded through the public internet, or a similar communications network. The multicast data packets can then be received by an access system that provides an interface to a large number of end users, such as set top boxes.

FIG. 1 shows an example of a prior-art access system 100. As shown in FIG. 1, system 100 includes a control bus 110 and a number of host line cards 112 that are connected to control bus 110. Control bus 110, which passes only non-packet control messages, can be implemented with, for example, a low-speed, Ethernet-type bus.

The host line cards 112, which can be implemented with, for example, xDSL line cards, each includes a logic block 112A. Logic block 112A, in turn, includes logic circuitry and a memory that stores a host table. The host table indicates the television channel that is received by each end user (e.g., set top box (STB)) that is connected to host line card 112. In the FIG. 1 example, only one host line card 112 is shown for purposes of simplicity.

As further shown in FIG. 1, system 100 includes a number of multicast line cards 114 that are connected to control bus 110. Each multicast line card 114 includes a logic block 114A which, in turn, includes logic circuitry and a memory that stores a forwarding table. The forwarding table includes the multicast group addresses of the television channels that are received by multicast line card 114, the host line cards 112 that are to receive the television channels, and the path to the host line cards 112.

In addition, each multicast line card 114 is also connected to a forwarding unit, such as a router that receives multicast data packets from a video head end (HE), to receive a number of television channels. In the FIG. 1 example, only one multicast line card 114 is shown for purposes of simplicity.

System 100 additionally includes a fabric switch module card 116 that is connected to control bus 110, and between the host line cards 112 and the multicast line cards 114. Fabric switch module card 116, which can pass data packets between the line cards at up to OC12 speeds, includes a data path 118 that is connected to host line card 112 and multicast line card 114.

In operation, when multicast line card 114 receives a multicast data packet, multicast line card 114 forwards the multicast data packet to the host line cards 112 via data paths within fabric switch module card 116 as indicated in the forwarding table. For example, when multicast line card 114 receives channel 2, card 114 forwards channel 2 to host line card 112 via data path 118 when host line card 112 and data path 118 are associated with channel 2 in the forwarding table.

Thus, before multicast line card 114 can forward a television channel to host line card 112, multicast line card 114 must first associate host line card 112 and a data path with the multicast group address of the television channel in the forwarding table. As a result, when the forwarding table includes N television channels, and host line card 112 is associated with M of the N channels, multicast line card 114 forwards the M channels to host line card 112.

System 100 additionally includes a primary control module (PCM) card 120 that is connected to control bus 110. PCM card 120 includes a memory and a processor that is connected to the memory. The memory has a first PCM table that includes all of the multicast group addresses of the television channels that are received by each of the host line cards 112. The memory also has a second PCM table that includes all of the multicast group addresses of the television channels that are received by all of the multicast line cards 114.

The memory can also store an operating system and a set of program instructions. The operating system can be implemented with, for example, the Linux operating system, although other operating systems can alternately be used. The program instructions can be written in, for example, C++ although other languages can alternately be used.

The processor, which can be implemented with, for example, a 32-bit processor, operates on the data in the first and second PCM tables in response to the program instructions. Although only one processor is described, multiple processors in parallel an also be utilized to increase the capacity to process large amounts of data. (PCM card 120 also includes circuitry for inserting information into the memory, and removing information from the memory.)

System 100 further includes a secondary control module (SCM) card 122 that is connected to control bus 110. SCM card 122, which also includes a memory and a processor that is connected to the memory, is identical to PCM card 120. Although physically identical to PCM card 120, SCM card 122 does not hold the data that is held by PCM card 120.

In operation, when an end user wishes to join a group (receive a television channel), the end user outputs an unsolicited version two (V2) membership report which, among other things, identifies the multicast group address of the group (television channel) that the end user wishes to receive. For example, when the end user wishes to receive television channel 2, the end user outputs an unsolicited V2 membership report to host line card 112 that identifies the multicast group address of television channel 2.

When host line card 112 receives a first join message in an unsolicited V2 membership report, host line card 112 sends a non-packet control message to PCM card 120. When the first PCM table indicates that the multicast group address of the television channel identified in the unsolicited V2 membership report is not received by host line card 112, but the second PCM table indicates that the multicast group address is currently received by multicast line card 114, PCM card 120 sends a non-packet control message to multicast line card 114 via bus 110. The control message instructs multicast line card 114 to associate host line card 112 with the television channel in the forwarding table to receive the television channel.

For example, when channel 2 is not received by host line card 112, but the second PCM table indicates that multicast line card 114 is currently receiving television channel 2, PCM card 120 sends a control message to multicast line card 114 to associate host line card 112 with channel 2 in the forwarding table to allow multicast line card 114 to forward channel 2 to host line card 112.

When an end user wishes to no longer receive a multicast data packet from a group (television channel), the end user outputs a leave message to the associated host line card 112. When host line card 112 receives a last leave message, host line card 112 sends a non-packet control message to PCM card 120. PCM card 120 then de-associates the multicast group address of the group (television channel) from host line card 112 in the first PCM table, which includes the multicast group addresses that are received by host line card 112.

For example, when host line card 112 receives a leave message from an end user which identifies the multicast group address of channel 9, and the end user is the last end user of host line card 112 to leave channel 9, PCM card 120 de-associates the multicast group address of channel 9 with host line card 112 in the first PCM table.

In addition, PCM card 120 sends a non-packet control message to multicast line card 114, which is the source of the television channel forwarded (with the multicast group address) to host line card 112. The control message instructs multicast line card 114 to de-associate host line card 112 and the television channel in the forwarding table so that host line card 112 no longer receives the television channel.

For example, when multicast line card 114 is currently forwarding television channel 9 to host line card 112, PCM card 120 sends a non-packet control message to multicast line card 114 to de-associate host line card 112 and television channel 9 in the forwarding table to prevent multicast line card 114 from forwarding channel 9 to host line card 112.

During normal operation, when an end user switches from a first television channel to a second television channel, host line card 112 receives a leave message (that identifies the first channel) followed by a join message (that identifies the second channel). In response to the leave message, host line card 112 immediately stops forwarding the first television channel identified in the leave message, and sends the leave message to PCM 120. In addition, host line card 112 sends the join message (unsolicited V2 membership report) to PCM 120.

However, when PCM card 120 is replaced by SCM card 122, any control messages sent to PCM card 120 during the switch over are lost. SCM card 122 can replace PCM card 120 for a number of reasons. For example, a control module switch over can happen when PCM card 120 and SCM card 122 are both present, PCM card 120 fails, and SCM card 122 assumes control. A control module switch over can also happen when only PCM card 120 is present, and PCM card 120 is removed and replaced with another control module card (e.g., SCM card 122).

After a control module transition has taken place, the new PCM card (e.g., original SCM card 122) queries all of the line cards 112 and 114. The new PCM card (e.g., original SCM card 122) then reconstructs the full membership information from the membership information received from the queries, and distributes the reconstructed full membership information to all of the line cards 112 and 114.

Thus, during a control module switch over, host line card 112 must wait until SCM card 122 can query all of the line cards 112 and 114, and reconstruct the full membership information in the first and second PCM tables (determine the channels received by the host line cards 112 and the multicast line cards 114) before host line card 112 can begin sending control messages to SCM card 122.

As a result, when a user changes from a first television channel to a second television channel during a control module switch over, host line card 112 immediately stops forwarding the first television channel identified in the leave message, but then must wait until the switch over is complete before the leave message and/or the subsequent join message can be sent to SCM card 122 to complete the change from the first television channel to the second television channel.

Thus, the user can experience a period of time while waiting for the switch over to end, ranging from tens of seconds up to a few minutes, depending on the reason SCM card 122 is replacing PCM card 120, where the end user receives no television signal. As a result, there is a need for a method and system that insures that a user receives a television signal when the user changes channels during a control module switch over.

### SUMMARY OF THE INVENTION

The present invention insures that a user receives a television signal when the user changes channels during a control module switch over. The present invention includes a method of operating a first line card that is connected to a primary control module (PCM) card and a second line card via a control bus, and to the second line card via a switching network. The method includes the steps of determining whether control information has been received from an end user, and sending control information to the PCM card via the control bus when control information has been received.

The present invention also includes a method of operating a first line card that is connected to a primary control module (PCM) card and a second line card via a control bus, and to the second line card via a switching network. The method includes the step of receiving a multicast data packet from a data source. The multicast data packet includes a multicast group address.

The method also includes the step of checking a forwarding table stored on the first line card to determine destinations that correspond with the multicast group address. The method further includes the step of forwarding the data packet to the second line card via the switching network when the second line card is associated with the multicast group address in the service table.

The present invention also includes a communications system. The communications system includes a control bus, a switching network, and a primary control module (PCM) card that is connected to the control bus. The communications system also includes a first line card that is connected to the control bus and the switching network. The first line card has a first logic block. The communications system further includes a second line card that is connected to the control bus and the switching network. The second line card has a second logic block.

A better understanding of the features and advantages of the present invention will be obtained by reference to the following detailed description and accompanying drawings that set forth an illustrative embodiment in which the principles of the invention are utilized.

### BRIEF DESCRIPTION OF THE DRAWINGS

FIG. 1 is a block diagram illustrating a prior-art access system 100.

FIG. 2 is a block diagram illustrating an example of an access system 200 in accordance with the present invention.

FIG. 3 is a flow chart illustrating an example of a method 300 of operating host line card 112 in accordance with the present invention.

FIG. 4 is a flow chart illustrating an example of a method 400 of operating multicast line card 114 in accordance with the present invention.

FIG. 5 is a flow chart further illustrating an example of a method 500 of operating multicast line card 114 in accordance with the present invention.

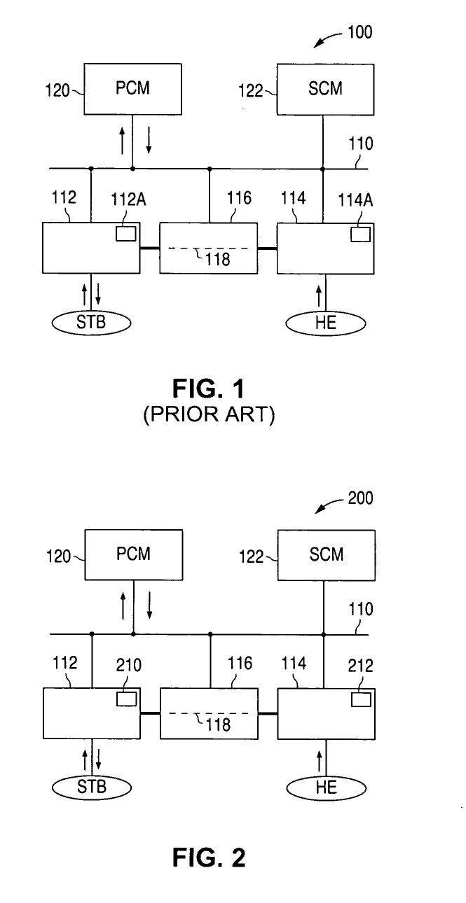

### DETAILED DESCRIPTION OF THE INVENTION

FIG. 2 shows a block diagram that illustrates an example of an access system 200 in accordance with the present invention. As described in greater detail below, system 200 insures that a user receives a television signal when the user changes channels during a control module switch over.

System 200 is similar to system 100 and, as a result, utilizes the same reference numerals to designate the structures which are common to both systems. As shown in FIG. 2, system 200 differs from system 100 in that each host line card 112 in system 200 has a logic block 210 that includes logic circuitry and a memory that stores the host table. Logic block 210, in turn, can be implemented with an application specific integrated circuit (ASIC).

As further shown in FIG. 2, communications system 200 further differs from system 100 in that each multicast line card 114 in system 200 has a logic block 212 that includes logic circuitry and a memory that stores the forwarding table. Logic block 214 can be implemented with an ASIC.

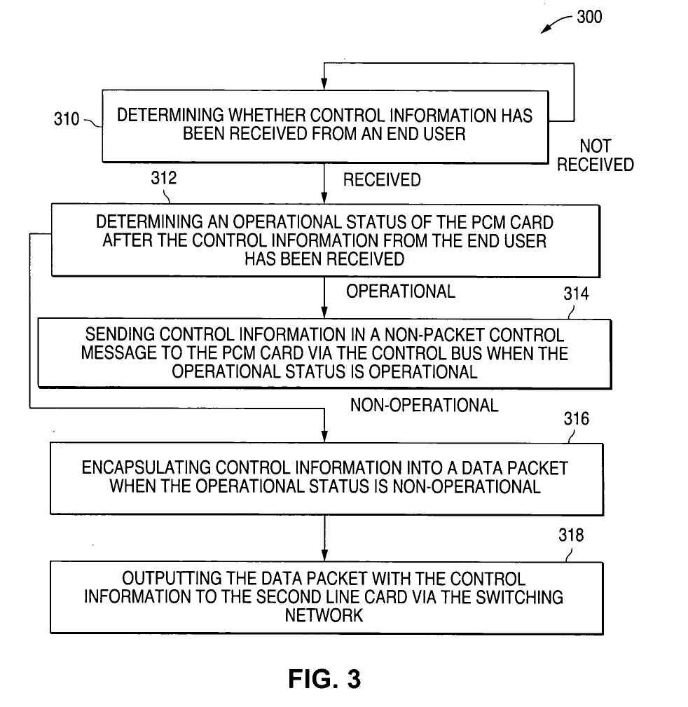

FIG. 3 shows a flow chart that illustrates an example of a method 300 of operating host line card 112 in accordance with the present invention. Method 300 can be implemented by logic module 210. As shown in FIG. 3, method 300 begins at step 310 by determining whether control information has been received from an end user. For example, host line card 112 can receive an unsolicited V2 membership report from one of a number of end users that can be connected to host line card 112.

When control information has been received, method 300 moves to step 312 to determine an operational status of the associated PCM card, such as PCM card 120. For example, fabric switch module card 116 or SCM card 122 can output a status signal, such as an interrupt signal, to each member of control bus 110 to indicate the non-operational status of PCM card 120 when PCM card 120 is removed for replacement.

Alternately, fabric switch module card 116 or SCM card 122 can monitor a signal output by PCM card 120 which, when no longer present, indicates that PCM card 120 is non-operational. In this case, the detecting card outputs a status signal to each member of control bus 110 to indicate the operational status of PCM card 120. Host line card 112 can then detect the logic state of the status signal to determine the operational status of PCM card 120.

When the PCM card is operational, method 300 moves to step 314 to send control information in a non-packet control message to the PCM card via the control bus. For example, host line card 112 can send non-packet control information from the control message to PCM 120 card via control bus 110.

On the other hand, when the PCM card is non-operational, method 300 moves to step 316 to encapsulate the control information into a data packet. For example, host line card 112 can encapsulate the control information into a data packet. Following this, method 300 moves to step 318 to output the data packet with the control information to the multicast line card (that forwards the television channel) via a data path of the fabric switch module card. For example, host line card 112 can output the data packet to multicast line card 114 via a data path 118 of fabric switch module card 116.

Thus, in accordance with the present invention, rather than waiting until queried by SCM 122, when host line card 112 detects the non-operational status of the PCM card, host line card 112 sends the control information encapsulated in the data packet directly to the multicast line card, such as card 114, (which is the source of the television channels forwarded to host line card 112) without notifying SCM card 122 and without using control bus 110.

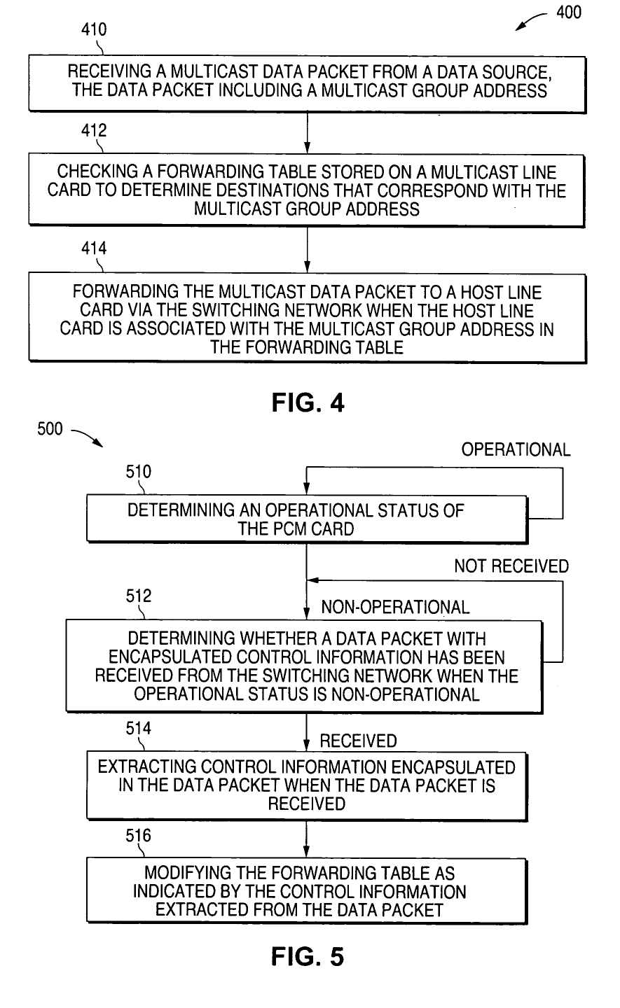

FIG. 4 shows a flow chart that illustrates an example of a method 400 of operating multicast line card 114 in accordance with the present invention. As shown in FIG. 4, method 400 begins at step 410 by receiving a multicast data packet from a data source where the multicast data packet includes a multicast group address.

When a multicast data packet is received, method 400 moves to step 412 to check a forwarding table stored on a multicast line card to determine destinations that correspond with the multicast group address. Following this, method 400 moves to step 414 to forward the multicast data packet to a host line card via the switching network when the host line card is associated with the multicast group address.

FIG. 5 shows a flow chart that further illustrates an example of a method 500 of operating multicast line card 114 in accordance with the present invention. Method 500 can be implemented with logic module 212 at the same time that method 400 is performed. As shown in FIG. 5, method 500 begins at step 510 by determining an operational status of the PCM card. For example, when fabric switch module card 116 and/or SCM 122 output a status signal that indicates whether PCM card 120 is operational or not, card 114 can detect the logic state of the status signal.

When the PCM card is non-operational, method 500 moves to step 512 to determine whether a data packet with encapsulated control information has been received from fabric switch module card 116. When a data packet is received, method 500 moves to step 514 to extract the control information encapsulated in the data packet. Following this, method 500 moves to step 516 to modify the forwarding table as indicated by the control information extracted from the data packet.

For example, when the control information is a join message, method 500 associates the host line card with the television channel that corresponds with the multicast group address in the forwarding table. When the control information is a leave message, method 500 de-associates the host line card from the television channel that corresponds with the multicast group address in the forwarding table.

Thus, in accordance with the present invention, when multicast line card 114 detects the non-operational status of PCM card 120, multicast line card 114 begins monitoring fabric switch module card 116 for a data packet with encapsulated control information. When a data packet is detected, multicast line card 114 responds to the control information within the packet as though it had come from PCM card 120.

As a result, multicast line card 114 can begin to forward a new television channel to host line card 112 even before SCM 122 has reconstructed the first and second PCM tables. Thus, the present invention insures that a user receives a television signal when the user changes channels during a control module switch over.

When the new PCM (original SCM 122) takes control and queries all of the line cards 112 and 114 after the control module transition has been completed, any changes which have taken place are identified by the new PCM (original SCM 122) as the new PCM works to reconstruct the full membership information held in the first and second PCM tables.

It should be understood that the above descriptions are examples of the present invention, and that various alternatives of the invention described herein may be employed in practicing the invention. Thus, it is intended that the following claims define the scope of the invention and that structures and methods within the scope of these claims and their equivalents be covered thereby.

What is claimed is:

1. A method of operating a first line card connected to a primary control module (PCM) card and a second line card via a control bus, and to the second line card via a switching network, the method comprising the steps of:
determining whether control information has been received from an end user; and
sending control information to the PCM card via the control bus when control information has been received.

2. The method of claim 1 and further comprising the steps of:
determining an operational status of the PCM card after the control information from the end user has been received and before sending control information to the PCM card; and
encapsulating the control information into a data packet when the operational status is non-operational.

3. The method of claim 2 and further comprising the step of outputting the data packet with the control information to the second line card via the switching network.

4. The method of claim 3 and further comprising the step of detecting a state of a status signal to determine the operational status of the PCM card.

5. The method of claim 4 wherein the status signal is an interrupt signal.

6. The method of claim 3 wherein the PCM card forwards control data to the second line card in response to control information received from the first line card.

7. The method of claim 3 wherein the first line card receives multicast data packets from the second line card and control information from the PCM card.

8. A method of operating a first line card connected to a primary control module (PCM) card and a second line card via a control bus, and to the second line card via a switching network, the method comprising the steps of:
receiving a multicast data packet from a data source, the multicast data packet including a multicast group address;
checking a forwarding table stored on the first line card to determine destinations that correspond with the multicast group address; and
forwarding the data packet to the second line card via the switching network when the second line card is associated with the multicast group address in the forwarding table.

9. The method of claim 8 and further comprising the steps of:
determining an operational status of the PCM card; and
determining whether a data packet with encapsulated control information has been received from the switching network when the operational status is non-operational.

10. The method of claim 9 and further comprising the step of extracting control information encapsulated in the data packet when the data packet is received.

11. The method of claim 10 and further comprising the step of modifying the forwarding table as indicated by the control information extracted from the data packet.

12. The method of claim 9 and further comprising the step of detecting a status signal to determine the operational status of the PCM card.

13. The method of claim 12 wherein the status signal is an interrupt signal.

14. The method of claim 9 wherein the PCM card forwards control data to the first line card in response to control information received from the second line card.

15. The method of claim 9 wherein first line card outputs multicast data packets to the second line card and receives control messages from the PCM card.

16. A communications system comprising:
a control bus;
a switching network;
a primary control module (PCM) card connected to the control bus;
a first line card connected to the control bus and the switching network, the first line card having a first logic block; and
a second line card connected to the control bus and the switching network, the second line card having a second logic block.

17. The communications system of claim 16 wherein the first logic block:
determines whether control information has been received from an end user;
determines an operational status of the PCM card after the control information from the end user has been received; and
encapsulates the control information into a data packet when the operational status of the PCM card is non-operational.

18. The communications system of claim 17 wherein the first logic block outputs the data packet to the second line card via the switching network.

19. The communications system of claim 16 wherein the second logic block:
determines the operational status of the PCM card; and
determines whether a data packet has been received from the switching network when operational status of the PCM card is non-operational.

20. The communications system of claim 19 wherein the second logic block:
extracts control information from the data packet; and
modifies a forwarding table as indicated by the control information extracted from the data packet.
